(19) United States
(12) Patent Application Publication
(10) Pub. No.: US 2015/0092673 A1
(43) Pub. Date: Apr. 2, 2015

(54) CUSTOMIZED COEXISTENCE MANAGEMENT BASED ON USER BEHAVIOR

(71) Applicant: Apple Inc., Cupertino, CA (US)

(72) Inventors: Ajoy K. Singh, Milpitas, CA (US); Wen Zhao, San Jose, CA (US)

(73) Assignee: Apple Inc., Cupertino, CA (US)

(21) Appl. No.: 14/041,723

(22) Filed: Sep. 30, 2013

(51) Int. Cl. H04W 72/02; H04W 4/02; H04W 8/18; H04W 28/02

(52) U.S. Cl. CPC H04W 72/02; H04W 28/0215; H04W 4/02; H04W 8/183
USPC 370/329

(57) ABSTRACT

A method for customized coexistence management based on user behavior is disclosed. The method can include a wireless communication device determining a behavior pattern of a user of the wireless communication device; assigning a priority level to each of a first application and a second application based on the behavior pattern; using a first wireless communication interface to support data communication for the first application; using a second wireless communication interface to support data communication for the second application concurrent with data communication for the first application over the first wireless communication interface; and managing in-device coexistence of the first wireless communication interface and the second wireless communication interface during concurrent data communication for the first application and the second application based on the priority level assigned to the first application and the priority level assigned to the second application.

### FIELD OF THE DESCRIBED EMBODIMENTS

The described embodiments relate generally to wireless communications and more particularly to providing customized in-device coexistence management based on user behavior.

### BACKGROUND

Many wireless communication devices support multiple wireless communication technologies and may concurrently communicate via multiple wireless communication technologies, and, thus, via multiple radio links. In many instances, wireless communication technologies used by a device can use channel bands that may interfere with each other. In such instances, energy from a band used by one technology can leak into a band used by another technology. This energy leakage can raise the noise floor and cause a problem known as desense. In many instances, desense can negatively impact the use of certain channel bands and, in severe cases, can render certain channel bands unusable. Accordingly, interference that can result in desense poses a problem for in-device coexistence of multiple wireless communication technologies.

A particularly troublesome in-device coexistence condition can result from a scenario in which a device emits a transmission via a first wireless communication technology, referred to as an aggressor technology, while the device is receiving data via a second wireless communication technology, referred to as a victim technology. Data receipt by the victim technology can be damaged by desense interference from the aggressor transmission. In this regard, received packet errors, or even complete deafening of the victim technology receiver can result from the interference that can be caused by the aggressor technology transmission. For example transmission of a cellular signal by a device at a time when a Bluetooth or wireless local area network (WLAN) signal is received can deafen the Bluetooth or WLAN receiver, causing errors and, in some cases, complete loss of connection.

Many wireless communication devices supporting multiple wireless communication technologies accordingly implement coexistence management policies in an attempt to reduce or avoid in-device interference resulting from concurrent communication via multiple radio links. However, existing coexistence management policies are generally static policies, such as may be defined by network service providers, which are applied across multiple devices and users. For example, data traffic on an aggressor radio link is often penalized by default regardless of the relative level of importance between the data traffic on the aggressor radio link and data traffic on the victim radio link. These static policies fail to take into account the preferences of specific users and, thus often to fail to provide a good quality of experience for users.

### BRIEF SUMMARY OF SOME EMBODIMENTS

Some example embodiments disclosed herein address deficiencies in existing coexistence management techniques by providing customized coexistence management based on user behavior. More particularly, a wireless communication device in accordance with some example embodiments can assign a priority level to each of a plurality of applications implemented on the wireless communication device based at least in part on an observed behavior pattern of a user of the device. In this regard, such example embodiments can uniquely prioritize applications for a given user based on the historical behavior pattern of the user. The wireless communication device of such example embodiments can use the user-specific priority levels to make coexistence management decisions when data communication for a first application is ongoing over a first wireless communication interface concurrent with data communication for a second application over a second wireless communication interface. Thus, for example, if the user's past behavior pattern indicates that the first application is a higher priority application to the user than the second application, coexistence management decisions can be made to avoid penalizing throughput of data communication for the first application to reduce interference with data communication for the second application. Accordingly, a quality of service for the first application can be preserved, thereby providing a better user experience than if throughput for the first application were reduced in accordance with a static, one-size-fits-all coexistence policy. Such example embodiments provide customized, user-specific coexistence management, thereby providing users with an improved quality of experience.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a wireless communication system in accordance with some example embodiments.

FIG. 2 illustrates a block diagram of an example apparatus that can be implemented on a wireless communication device in accordance with some example embodiments.

FIG. 3 illustrates a system layer diagram in accordance with some example embodiments.

FIG. 4 illustrates a flowchart according to an example method for customized coexistence management based on user behavior in accordance with some example embodiments.

FIG. 5 illustrates a flowchart according to an example method for assigning priority levels to applications based on user behavior in accordance with some example embodiments.

FIG. 6 illustrates a flowchart according to an example method for managing radio resources for location-based services based on user behavior in accordance with some example embodiments.

FIG. 7 illustrates a flowchart according to an example method for selecting a wireless communication interface for an application based on user behavior in accordance with some example embodiments.

FIG. 8 illustrates a flowchart according to an example method for switching a wireless communication interface for an application in accordance with some example embodiments.

FIG. 9 illustrates an example system for synchronizing behavior patterns across multiple wireless communication devices in accordance with some example embodiments.

### DETAILED DESCRIPTION OF SELECTED EMBODIMENTS

Some example embodiments disclosed herein provide customized coexistence management based on user behavior. More particularly, some example embodiments assign a priority level to each of a plurality of applications implemented on the wireless communication device based at least in part on an observed behavior pattern of a user of the device. In this regard, such example embodiments can uniquely prioritize applications for a given user based on the historical behavior pattern of the user. The wireless communication device of such example embodiments can use the user-specific priority levels to make coexistence management decisions when data communication for a first application is ongoing over a first wireless communication interface concurrent with data communication for a second application over a second wireless communication interface. Thus, for example, in some embodiments, if the user's past behavior pattern indicates that the first application is a higher priority application to the user than the second application, coexistence management decisions can be made to avoid penalizing throughput of data communication for the first application to reduce interference with data communication for the second application. Accordingly, when a potential for in-device coexistence exists due to concurrent data communication for multiple applications, coexistence decisions can be made to provide a user with a better quality of experience based on a relative importance of the active applications to the user based on past behavior of the user.

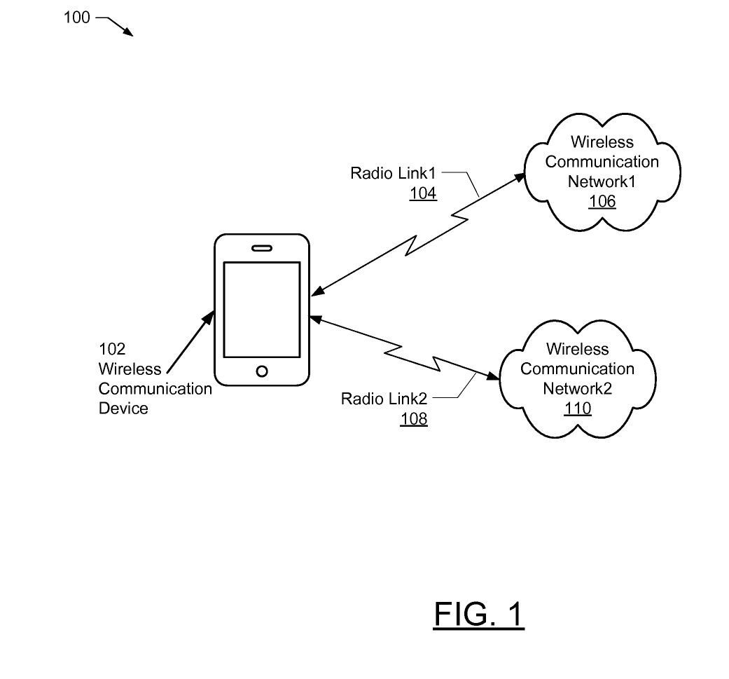

FIG. 1 illustrates a wireless communication system 100 including a wireless communication device 102 in accordance with some example embodiments. The wireless communication device 102 can be any computing device configured to wirelessly access one or more wireless networks and/or wirelessly communicate with one or more further wireless communication devices in accordance with various example embodiments. By way of non-limiting example, the wireless communication device 102 can be embodied as a cellular phone, such as a smart phone device, a tablet computing device, a laptop computer, and/or other computing device that can be configured to access a wireless network and/or wirelessly communicate with a further wireless communication device.

The wireless communication device 102 can include a plurality of wireless communication interfaces. Each wireless communication interface can be configured to support communication between the wireless communication device 102 and a wireless network and/or a further wireless communication device via a radio access technology (RAT). For example, a wireless communication interface can be configured to support a radio link between the wireless communication device 102 and a network access point for a wireless communication network. As a further example, a wireless communication interface can be configured to support a radio link between the wireless communication device 102 and a further wireless communication device.

The wireless communication device 102 of some example embodiments can include one or more cellular communication interfaces, which can enable the wireless communication device 102 to access a cellular network, such as via a radio link to a cellular base station. In embodiments in which the wireless communication device 102 includes one or more cellular communication interfaces, the cellular communication interface(s) can, for example, be configured to support communication via a Long Term Evolution (LTE) cellular communication technology, an LTE-Advanced (LTE-A) cellular communication technology, a Universal Mobile Telecommunications System (UMTS) cellular communication technology, a Global System for Mobile Communications (GSM) cellular communication technology, a Code Division Multiple Access (CDMA) cellular communication technology, a CDMA 2000 cellular communication technology, and/or other cellular communication technology.

In some example embodiments, the wireless communication device 102 can additionally or alternatively include one or more wireless local area network (WLAN) communication interfaces. A WLAN communication interface can be configured to support a radio link with a WLAN access point, such as in a structured WLAN, and/or a radio link with another wireless communication device, such as in an unstructured, or ad-hoc, WLAN. A WLAN communication interface can be configured to support communication via any WLAN RAT, such as, by way of example, a RAT implementing an Institute of Electrical and Electronics Engineers (IEEE) 802.11 standard (e.g., 802.11a, 802.11b, 802.11g, 802.11n, 802.11ac, 802.11ad, and/or other present or future developed version of 802.11).

The wireless communication device 102 of some example embodiments can additionally or alternatively include one or more wireless personal area network (WPAN) communication interfaces. A WPAN communication interface can be configured to support a radio link for communication in a WPAN in accordance with any WPAN RAT, such as, Bluetooth, Zigbee, Z-Wave, Wireless Universal Serial Bus (USB), and/or the like. In some example embodiments, the wireless communication device 102 can include a WPAN communication interface supporting communication in accordance with a version of the IEEE 802.15 standard.

In some example embodiments, the wireless communication device 102 can include one or more global navigation satellite system (GNSS) communication interfaces. A GNSS communication interface can be configured to support a radio link to a satellite navigation service, such as, the Global Positioning System (GPS), the Beidou navigation system, the Galileo positioning system, the Russian GLONASS system, and/or the like, that can be used by the wireless communication device 102 of some example embodiments to ascertain a location of the wireless communication device 102.

It will be appreciated that the foregoing example types of wireless communication interfaces that can be implemented on the wireless communication device 102 are provided by way of non-limiting example. In this regard, the wireless communication device 102 of some example embodiments can include an alternative type(s) of wireless communication interface in addition to or in lieu of those described above.

In some instances, the wireless communication device 102 can concurrently utilize multiple wireless communication interfaces. In this regard, the wireless communication device 102 can, in some instances, communicate data via multiple established radio links at a given time. Data communicated via a wireless communication interface over a radio link can be associated with an active application (or applications) on the wireless communication device 102. In the example of FIG. 1, two radio links are illustrated by way of example.

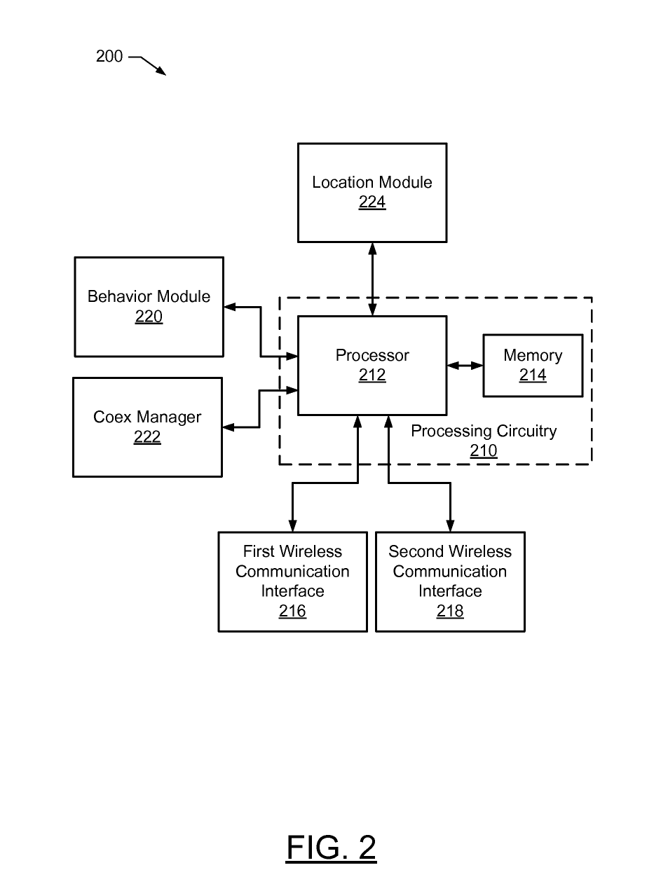

The radio link1 104 can be supported by a first wireless communication interface, such as first wireless communication interface 216 illustrated in and discussed below with respect to FIG. 2, and can provide a radio communication link between the wireless communication device 102 and wireless communication network1 106. The wireless communication network1 106 can, by way of non-limiting example, be a cellular network, WLAN, WPAN, GNSS network, and/or other type of structured or ad hoc wireless network. The radio link1 104 can accordingly, for example, provide a radio link between the wireless communication device 102 and an access point (e.g., a cellular base station, WLAN access point, and/or the like) for the wireless communication network1 106. Additionally or alternatively, as a further example, the radio link1 104 can provide a radio link between the wireless communication device 102 and a further wireless communication device(s), which may, collectively, form at least a portion of the wireless communication network1 106. The radio link1 104 can accordingly use any RAT supported by the second wireless communication interface and the wireless communication network1 106.

The radio link2 108 can be supported by a second wireless communication interface, such as the second wireless communication interface 218 illustrated in and discussed below with respect to FIG. 2, and can provide a radio communication link between the wireless communication device 102 and wireless communication network2 110. The wireless communication network2 110 can, by way of non-limiting example, be a cellular network, WLAN, WPAN, GNSS network, and/or other type of structured or ad hoc wireless network. The radio link2 108 can accordingly, for example, provide a radio link between the wireless communication device 102 and an access point (e.g., a cellular base station, WLAN access point, and/or the like) for the wireless communication network2 110. Additionally or alternatively, as a further example, the radio link2 108 can provide a radio link between the wireless communication device 102 and a further wireless communication device(s), which may, collectively, form at least a portion of the wireless communication network2 110. The radio link2 108 can accordingly use any RAT supported by the second wireless communication interface and the wireless communication network2 110.

While two radio links are illustrated in FIG. 1, it will be appreciated that this illustration is by way of example. In this regard, the wireless communication device 102 of some example embodiments can include three or more wireless communication interfaces and can have three or more corresponding active radio links. As such, it will be appreciated that techniques described herein with respect to examples involving two wireless communication interfaces and/or two active radio links can be applied mutatis mutandis to devices and scenarios having three or more wireless communication interfaces and/or three or more active radio links within the scope of the disclosure.

Concurrent data communication of data via multiple wireless communication interfaces (e.g., via radio link1 104 and radio link2 108) can cause in-device interference in the wireless communication device 102 such that data communication via one communication interface can interfere with the data communication via another communication interface. In this regard, interference can result from a transmission emitted over a first radio link, such as radio link1 104, by a wireless communication interface using an aggressor RAT while another wireless communication device is receiving data via a second radio link, such as radio link2 108, using a victim RAT. In such situations, the aggressor RAT transmissions can inhibit data reception via the victim RAT, potentially resulting in received data errors, or in extreme cases, even completely deafening the victim technology receiver. This radio frequency (RF) interference can be caused by a number of side effects that can result from concurrent data communication via multiple wireless communication interfaces on the wireless communication device 102.

For example, RF interference can result from adjacent channel interference (ACI), in which transmit energy spills over into adjacent bands that may be used by a victim RAT. This problem can also be referred to as out-of-band (OOB) interference. As a more particular example, a cellular radio band that can be used by a cellular communication interface can be adjacent to an Industrial, Scientific, Medical (ISM) band that can be used by a WLAN communication interface and/or a WPAN communication interface. For example, a cellular communication interface supporting communication via an LTE rat and using LTE band 40 using time-division duplexing (TDD) in the 2300-2400 MHz band range and/or LTE band 7 using frequency-division duplexing (FDD) in the 2500-2570 MHz band range can act as an aggressor such that transmissions by the cellular communication interface via these bands can interfere with reception via a WLAN communication interface and/or WPAN communication interface operating in the adjacent 2400 GHz ISM band. In this regard, transmit energy from the LTE bands can spill over into the band(s) used by a WLAN communication interface and/or WPAN communication interface, potentially interfering with data reception by the WLAN communication interface and/or the WPAN communication interface.

As another example, intermodulation distortion can result in RF interference that can harm reception by a wireless communication interface. In this regard, harmonics can be generated when two or more transmit frequencies “mix” with each other due to non-linearity. For example, cellular bands 5 and/or 8 can mix with 2.4 GHz ISM band transmissions to desense a GNSS receive band that may be used by a GNSS communication interface. As still a further example, RF interference can result form harmonic distortion in which harmonics can be generated from a single transmit frequency due to a non-linearity.

The wireless communication device 102 can accordingly implement any of a variety of in-device coexistence techniques that are known to those having ordinary skill in the art to reduce such in-device RF interference that may result from concurrent use of multiple wireless communication interfaces. As will be described further herein below, these coexistence techniques can be applied in some example embodiments based at least in part on an historical behavior pattern for a user of the wireless communication device.

FIG. 2 illustrates a block diagram of another example apparatus that can be implemented on a wireless communication device, such as wireless communication device 102, in accordance with some embodiments. In this regard, FIG. 2 illustrates an apparatus 200 that can, when implemented on a computing device, such as wireless communication device 102, enable the computing device to operate within the system 100 in accordance with one or more example embodiments. It will be appreciated that the components, devices or elements illustrated in and described with respect to FIG. 2 below may not be mandatory and thus some may be omitted in certain embodiments. Additionally, some embodiments can include further or different components, devices or elements beyond those illustrated in and described with respect to FIG. 2.

In some example embodiments, the apparatus 200 can include processing circuitry 210 that is configurable to perform actions in accordance with one or more example embodiments disclosed herein. In this regard, the processing circuitry 210 can be configured to perform and/or control performance of one or more functionalities of a wireless communication device in accordance with various example embodiments, and thus can provide means for performing functionalities of wireless communication device 102 in accordance with various example embodiments. The processing circuitry 210 can be configured to perform data processing, application execution and/or other processing and management services according to one or more example embodiments.

In some embodiments, the apparatus 200 or a portion(s) or component(s) thereof, such as the processing circuitry 210, can include one or more chipsets, which can each include one or more chips. The processing circuitry 210 and/or one or more further components of the apparatus 200 can therefore, in some instances, be configured to implement an embodiment on a single chip or chipset. In some example embodiments in which one or more components of the apparatus 200 are embodied as a chipset, the chipset can be capable of enabling a computing device to operate in the system 100 when implemented on or otherwise operably coupled to the computing device. In some such example embodiments, the apparatus 200 can, for example, include a cellular baseband chipset, a GNSS chipset, a WLAN chipset, a Bluetooth chipset, and/or the like.

In some example embodiments, the processing circuitry 210 can include a processor 212 and, in some embodiments, such as that illustrated in FIG. 2, can further include memory 214. The processing circuitry 210 can be in communication with, control, and/or otherwise be coupled with a plurality of wireless communication interfaces, such as the first wireless communication interface 216 and the second wireless communication interface 218, that can be implemented on the apparatus 200; behavior module 220, coex manager 222, and/or location module 224.

The processor 212 can be embodied in a variety of forms. For example, the processor 212 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 212 can comprise a plurality of processors. The plurality of processors can be in operative communication with each other and can be collectively configured to perform one or more functionalities of wireless communication device 102 as described herein. In some example embodiments, the processor 212 can be configured to execute instructions that can be stored in the memory 214 or that can be otherwise accessible to the processor 212. As such, whether configured by hardware or by a combination of hardware and software, the processor 212 capable of performing operations according to various embodiments while configured accordingly.

In some example embodiments, the memory 214 can include one or more memory devices. Memory 214 can include fixed and/or removable memory devices. In some embodiments, the memory 214 can provide a non-transitory computer-readable storage medium that can store computer program instructions that can be executed by the processor 212. In this regard, the memory 214 can be configured to store information, data, applications, instructions and/or the like for enabling the apparatus 200 to carry out various functions in accordance with one or more example embodiments. In some embodiments, the memory 214 can be in communication with one or more of the processor 212, one or more wireless communication interfaces (e.g., first wireless communication interface 216, second wireless communication interface 218, and/or the like), behavior module 220, coex manager 222, and/or location module 224 via a bus (or buses) for passing information among components of the apparatus 200.

The apparatus 200 can further include a plurality of wireless communication interfaces, including the first wireless communication interface 216 and the second wireless communication interface 218. While only two wireless communication interfaces are illustrated in FIG. 2, it will be appreciated that, in some example embodiments, the apparatus 200 can include two or more wireless communication interfaces. Each wireless communication interface implemented on the apparatus 200 can include, for example, an antenna (or multiple antennas) and supporting hardware and/or software for enabling communications in accordance with a RAT that can be supported by the wireless communication interface. In this regard, a wireless communication interface, such as the wireless communication interfaces 216 and 218, that can be implemented on the apparatus 200 can be configured to send (e.g., transmit) wireless signals and receive wireless signals over a radio link(s), such as radio link1 104 or radio link2 108. Accordingly, a wireless communication interface, such as the wireless communication interfaces 216 and 218, can be configured to support data communication with a wireless communication network and/or another wireless communication device within a wireless communication network.

In some example embodiments, a wireless communication interface, such as the first wireless communication interface 216 and/or the second wireless communication interface 218, can provide a physical layer (PHY) interface that can be used by a wireless communication device 102. Further, in some example embodiments, a wireless communication interface, such as the first wireless communication interface 216 and/or the second wireless communication interface 218, can be at least partially implemented as a chipset, which, when implemented on a device, such as the wireless communication device 102, can enable the device to transmit and/or receive data via a RAT that can be supported by the wireless communication interface. The wireless communication interfaces 216 and 218 can each support any type of RAT that can be used for communication between a wireless communication device, such as wireless communication device 102, and a further wireless communication device and/or wireless communication network. As such, it will be appreciated that the first wireless communication interface 216 and the second wireless communication interface 218 can each be embodied as any type of wireless communication interface, including, for example, a cellular communication interface, WLAN communication interface, WPAN communication interface, GNSS communication interface, some combination thereof, and/or the like.

The apparatus 200 can further include behavior module 220. The behavior module 220 can be embodied as various means, such as circuitry, hardware, a computer program product comprising a computer readable medium (for example, the memory 214) storing computer readable program instructions that are executable by a processing device (for example, the processor 212), or some combination thereof. In some embodiments, the processor 212 (or the processing circuitry 210) can include, or otherwise control the behavior module 220. The behavior module 220 can be configured to determine a behavior pattern of a user of the wireless communication device 102 based at least in part on historical usage of the wireless communication device 102 by the user, in accordance with one or more example embodiments disclosed herein. The behavior module 220 can be further configured to assign a priority level to each of a plurality of applications that can be implemented on the wireless communication device 102 based at least in part on the behavior pattern, in accordance with one or more example embodiments disclosed herein.

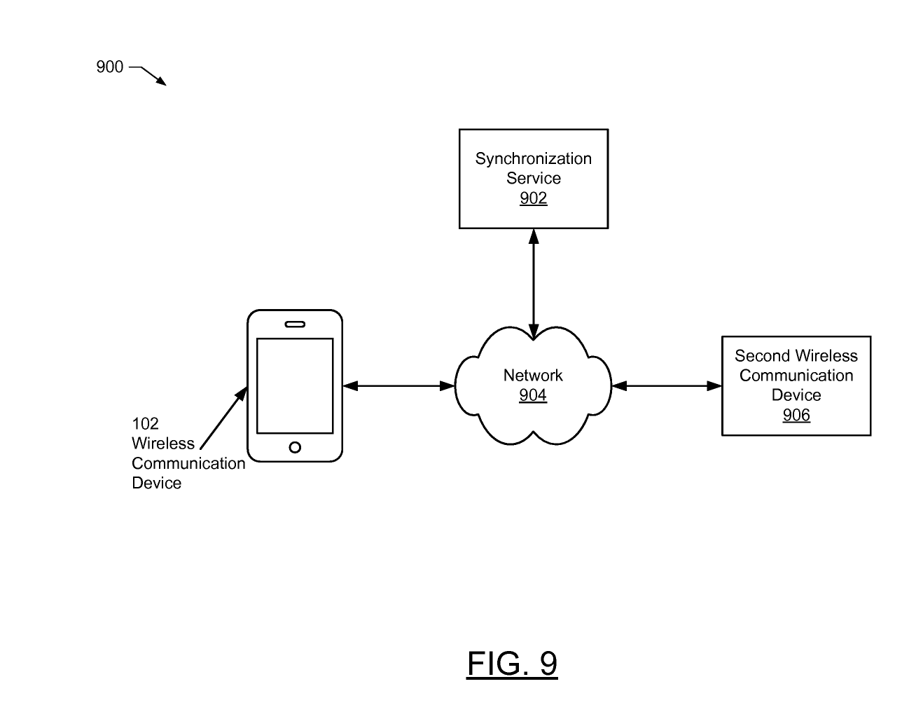

In some example embodiments, functionality of the behavior module 220 can be performed entirely at the wireless communication device 102. However, in some embodiments, such as some example embodiments described with respect to FIG. 9, at least some functionality of the behavior module 220 can be performed by a network entity, such as synchronization service 902, which can be in network communication with the wireless communication device 102. Thus, for example, in some embodiments, the behavior module 220 can be a distributed entity such that functionality of the behavior module 220 can be performed by multiple computing devices acting in cooperation over a network, such as the network 904 illustrated in and described below with respect to FIG. 9.

The apparatus 200 can additionally include coex manager 222. The coex manager 222 can be embodied as various means, such as circuitry, hardware, a computer program product comprising a computer readable medium (for example, the memory 214) storing computer readable program instructions that are executable by a processing device (for example, the processor 212), or some combination thereof. In some embodiments, the processor 212 (or the processing circuitry 210) can include, or otherwise control the coex manager 222. The coex manager 222 can be configured to manage coexistence of wireless communication devices, such as first wireless communication interface 216 and second wireless communication interface 218, on the apparatus 200. In some example embodiments, the coex manager 222 can be configured to use application priority levels that can be assigned by the behavior module 220 based on a user behavior pattern to make coexistence decisions with respect to concurrently active wireless communication interfaces.

The apparatus 200 can further include location module 224. The location module 224 can be embodied as various means, such as circuitry, hardware, a computer program product comprising a computer readable medium (for example, the memory 214) storing computer readable program instructions that are executable by a processing device (for example, the processor 212), or some combination thereof. The location module 224 can be configured to determine a location of the wireless communication device 102 via any one or more of a variety of techniques. For example, in some example embodiments, the location module 224 can be embodied as or otherwise include a GNSS communication interface, which can be configured to use a satellite positioning system to determine a location of the wireless communication device 102. As a further example, in some example embodiments, the location module 224 can be configured to determine a location of the wireless communication device 102 through application of techniques such as assisted GPS, signal triangulation, location determination based on a location identifier that can be sensed from a WLAN, location determination based on a cell ID for a serving cell, and/or the like. In some example embodiments, the location module 224 can additionally or alternatively include various sensors, such as an accelerometer, a gyroscope, and/or the like, which can be configured to sense motion of the wireless communication device 102. In some example embodiments, the location module 224 can include and/or can be operated via location-based service software and/or firmware, such as a location daemon. A location that can be determined by the location module 224 can, for example, include a coordinate location, a street address, a name of a political region (e.g., city, town, state, country, municipality, and/or the like) in which the wireless communication device 102 can be located, and/or other location reference that can be representative of an actual and/or relative location of the wireless communication device 102.

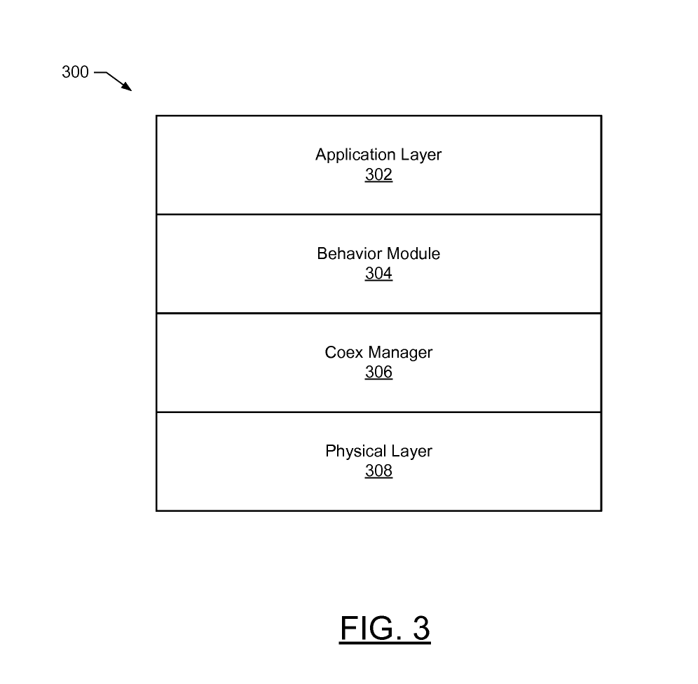

FIG. 3 illustrates a system layer diagram in accordance with some example embodiments. In this regard, FIG. 3 illustrates an arrangement of system layers 300 that can be implemented on wireless communication device 102 in accordance with some example embodiments.

The system layers 300 can include an application layer 302, which can, for example, be at least partially implemented by applications that can be executed on the processor 212. The system layers 300 can further include a behavior module 304, which can, for example, be implemented by the behavior module 220. In this regard, the behavior module 304 can be positioned such that user interactions with applications running in the application layer 302 can be monitored to ascertain a behavior pattern of a user of the wireless communication device 102. While illustrated in FIG. 3 as a separate layer from the application layer 302, in some embodiments, the behavior module 304 may be implemented within the application layer 302.

The system layers 300 can further include a coex manager 306 and physical layer 308. The coex manager 306 can, for example, be implemented by the coex manager 222. The physical layer 308 can be implemented by wireless communication interfaces, such as the first wireless communication interface 216 and second wireless communication interface 218, which can be included in the wireless communication device 102. The coex manager 306 can be positioned as an intermediary between the behavior module 304 and the physical layer 308. In this regard, the coex manager 306 can be configured to interact with the behavior module 304 to access priority levels that can be assigned by the behavior module 304 to applications implemented on the wireless communication device 102 on the basis of a user behavior pattern. The coex manager 306 can use the priority levels to manage coexistence of multiple wireless communication interfaces within the physical layer 308 in accordance with the respective priority levels assigned to applications that may be running in the application layer 302 and using the physical layer 308 for data communication.

It will be appreciated that the system layers 300 are provided by way of example, and not by way of limitation. In this regard, the system layers 300 are not to be taken as being comprehensive of all system layers that may be implemented on a wireless communication device 102. For example, one or more intermediate layers can be implemented between respective ones of the system layers 300 in accordance with some example embodiments. Further, alternative arrangements of the system layers 300, including arrangements in which two or more of the layers illustrated in FIG. 3 can be combined, are contemplated within the scope of the disclosure. As still another example, in some embodiments, the coex manager 306 can be a stand alone control entity that may not be implemented as an intermediary layer within a data communication path between the application layer 302 and physical layer 308.

Having now generally described the implementation and functionality of a wireless communication device in accordance with various example embodiments, several example embodiments will now be described in further detail with reference to the elements illustrated in and described with respect to FIGS. 1-3.

In some example embodiments, the behavior module 220 can be configured to determine a behavior pattern for a user of the wireless communication device 102 based at least in part on the user's historical usage of the wireless communication device 102. In this regard, the behavior module 220 can be configured to monitor and/or otherwise document usage of the wireless communication device 102 by a user associated with the wireless communication device 102 so as to learn the user's behavior and usage preferences. The monitored usage can include the user's usage of applications that can be implemented on the wireless communication device 102. By way of non-limiting example, such applications can include an email application, a text messaging application, voice call (e.g., voice over LTE, or VoLTE) application, a web browser application, specific web sites that can be viewed within a web browser application, a location-based service application, a streaming media application (e.g., an internet radio application), a social networking application, a news application, a virtual private network (VPN) application, a chat application, any of various mobile applications that can be installed on and/or otherwise accessed by a wireless communication device 102.

In some example embodiments, the behavior module 220 can be configured to determine a behavior pattern for a user based at least in part on any of a variety of characteristics of a user's usage of various applications that can be used to determine a behavior pattern for the user. For example, the behavior module 220 can be configured to monitor a frequency with which a user uses an application, a length of time that a user uses an application in a given session, a time frame (e.g., a morning, afternoon, evening, a certain day of the week, etc.) in which the user uses the application, whether data is uploaded and/or downloaded when the user uses an application, a volume of data uploaded and/or downloaded when the user uses an application, and/or other such usage characteristics.

As still a further example, in some example embodiments, the behavior module 220 can be configured to document a device usage context of the wireless communication device 102 when an application is used. The device usage context can, for example, include a physical and/or relative location of the wireless communication device 102, such as a user's home, user's office, on a train, in a car, a physical address, a town, and/or the like, which can be determined by the location module 224. Thus, for example, if a user tends to use a certain application frequently in a certain location, the association between the application and that location can be observed by the behavior module 220 and used to determine a behavior pattern for the user. As a further example, the device usage context can include an activity in which the user can be engaging and/or a device mobility scenario when using an application. For example, an accelerometer and/or other sensor that can be implemented on the location module 224 can be used to determine a user activity and/or mobility scenario, such as stationary, walking, jogging, in-car mobility, and/or the like. Thus, for example, if a user commonly uses a streaming media application when jogging, the association of the streaming media application with the device usage context of jogging can be observed by the behavior module 220 and used to determine a behavior pattern for the user. As another example, if a user commonly uses a navigation application when driving in a car, the association of the navigation application with the device usage context of driving in a car can be observed by the behavior module 220 and used to determine a behavior pattern for the user.

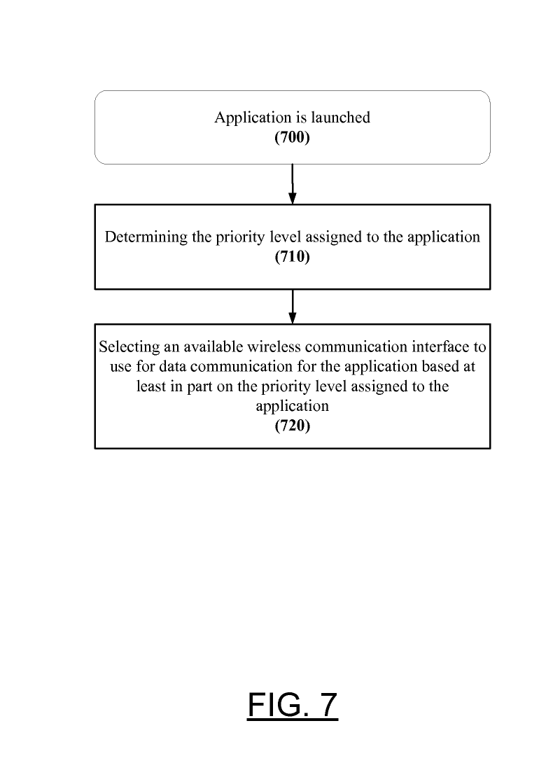

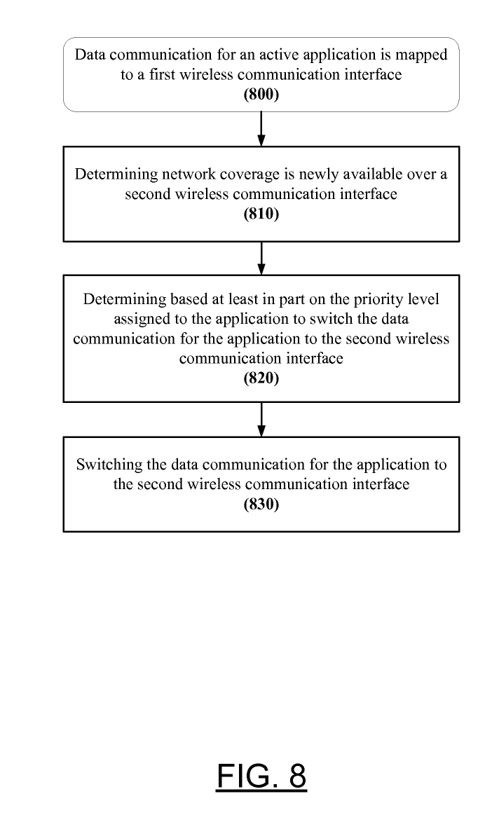

In some example embodiments, historic observations of network coverage characteristics for certain device usage contexts can also be included in a behavior pattern for a user. For example, throughput characteristics for a WLAN available at the user's home can be noted by the behavior module 220 in association with the device usage context of the user's home. In this regard, when the wireless communication device 102 encounters a particular device usage context, the coex manager 222 can use historical knowledge of network coverage characteristics for the device usage context to make coexistence management decisions, to select a wireless communication interface to use for the application (e.g., in accordance with the methods illustrated in and described below with respect to FIG. 7 and/or FIG. 8), and/or the like.

A behavior pattern for a user that can be determined by the behavior module 220 can be indicative of applications that are considered to be of value to the user based on the user's prior usage characteristics. Thus, for example, a first application that is used with greater frequency and/or for longer periods of time than a second application can be considered to be of higher value to the user than the second application based on the behavior pattern. In some example embodiments, the behavior pattern can be indicative of behavior patterns at different time frames (e.g., different times of day and/or different days of the week) and/or different device usage contexts. For example, the following can be a behavior pattern indicative of applications of high value to a user at given time frames, which can be determined based on historical device usage by an example user in accordance with some example embodiments:
Early morning high value applications: social networking application, news portal application
Mid-morning high value applications: VPN access and enterprise application
Afternoon high value application: chat application
Evening/weekend high value application: Location-based service application
Late night high value applications: Internet radio application, web browser

The behavior module 220 can be further configured to assign a priority level to each of a plurality of applications on the wireless communication device 102 based at least in part on a user's behavior pattern. In some example embodiments, the assigned priority levels can define a ranking, such as from 1 to n, with n being an integer number of applications ranked by priority, of applications in order of priority to the user based on the user's behavior pattern. As another example, in some embodiments, assignment of the priority levels can include classifying applications into certain defined priority levels, with multiple applications potentially being classified in a given priority level. For example, in such embodiments, applications can be assigned priority levels, such as “HIGH” priority, “MEDIUM” priority, “LOW” priority, and/or the like. Accordingly, a list of high priority (e.g., high value) applications associated with a device user can be maintained based on the user's behavior pattern.

In some example embodiments the behavior module 220 can be configured to assign a different set of priority levels for each of a plurality of periodically occurring time frames. In this regard, different sets of priority levels can be assigned for various time frames within a day (e.g., morning hours, afternoon hours, evening hours, etc.), for different days of the week, and/or for other time frames. For example, given the example behavior pattern of the example user above, a first set of priority levels can be defined for the “early morning” time frame, with the social networking application and news portal application being allocated high priority levels; a second set of priority levels can be defined for the “mid-morning” time frame, with VPN access and enterprise applications being allocated high priority levels; a third set of priority levels can be defined for the “afternoon” time frame, with the chat application being allocated a high priority level; a fourth set of priority levels can be defined for the “evening/weekend” time frame, with the location-based service application being allocated a high priority level; and a fifth set of priority levels can be defined for the “late night” time frame, with the Internet radio and web browser applications being allocated high priority levels.

In some example embodiments, the behavior module 220 can be additionally or alternatively configured to assign a different set of priority levels for each of a plurality of device usage contexts. For example, a different set of priority levels can be defined for each of a respective plurality of device locations, such as “home,” “office,” and/or other locations which the user may frequent. As a further example, a different set of priority levels can be defined for activity-based usage contexts, such as when driving in a car, riding on a train, exercising, and/or the like.

In some example embodiments, time frame and device usage contexts can be combined to generate combined time frame and device usage context scenarios for which respective priority level sets can be assigned. For example, a first set of priority levels can be assigned for a scenario in which a user is driving in a car between the hours of 7 AM and 9 AM and a second set of priority levels can be assigned for a scenario in which the user is exercising between the hours of 7 AM and 9 AM.

In some example embodiments, the behavior module 220 can be configured to additionally consider defined user interests in addition to behavior patterns when assigning priority levels to applications. For example, a user of the wireless communication device 102 can, in some example embodiments, define an interest profile that can be indicative of certain interests, preferences, and/or configuration settings associated with the user. The interest profile can, for example, be defined within an application that can be used for purposes of implementing behavior-based coexistence management in accordance with various example embodiments. Additionally or alternatively, as another example, the interest profile can include an interest profile that a user may have defined within in a social network.

In some example embodiments, there can be a plurality of defined behavior pattern categories (e.g., behavior personas). A user can be categorized in one of the defined behavior pattern categories based at least in part on the user's behavior pattern. In this regard, each behavior pattern category can represent a “bucket” defined based at least in part on a behavior pattern range, and the user can be categorized into the behavior pattern category which his or her behavior pattern most closely resembles.

In some example embodiments a user interest profile can be factored in addition to behavior pattern for categorizing a user in a defined behavior pattern category. Thus, for example, user interests, preferences, configuration settings, biographical details, and/or the like can be used to categorize a user into a certain behavior pattern category in accordance with some example embodiments.

A behavior pattern category can have an associated set of predefined application priority levels. Accordingly, in example embodiments in which the behavior module 220 categorizes users into a defined behavior pattern category corresponding to the user's observed behavior pattern, the behavior module 220 can be configured to assign priority levels to applications in accordance with the set of application priority levels defined by the behavior pattern category into which the user is classified.

In some example embodiments, a behavior pattern category can define a set of application priority levels for each of a plurality of time frames and/or for each of a plurality of device usage contexts. In such example embodiments, the behavior module 220 can accordingly be configured to defined time frame-specific and/or device usage context-specific application priority levels in accordance with the priority levels defined by the behavior pattern category into which the user is categorized.

In some example embodiments, a user can be can be categorized into different behavior pattern categories for different respective time frames and/or different respective device usage contexts. In this regard, a user's behavior pattern at a first time frame and/or for a first device usage context can correspond to a first behavior pattern category, while the user's behavior pattern at a second time frame and/or for a second device usage context can correspond to a second behavior pattern category. Accordingly, in such embodiments, application priority levels can be assigned for a given certain time frame and/or a given device usage context in accordance with the behavior pattern category in which the user is categorized for the time frame and/or device usage context.

In some example embodiments in which behavior pattern categories are representative of defined behavior personas, the behavior pattern categories can be representative of a stereotypical user having a certain occupation, life style, location of residence, and/or the like. For example, a “corporate” behavior pattern category can be defined. For a user, Tom, categorized in the corporate behavior pattern category, a VPN application can be defined to have a high priority level in the morning to enable the user to access office email in the morning. A VPN-related application can accordingly be given preferential coexistence treatment to a non-VPN related application in the morning for Tom. As another example, a “stay at home mom” behavior pattern category can be defined. For a user, Lisa, categorized in the stay at home mom behavior pattern category, a web browser application can be assigned a high priority level and given preferential coexistence treatment over other applications in the afternoon hours. As yet another example, a “teenager” behavior pattern category can be defined. For a user categorized in the teenager behavior pattern category, game applications and streaming media applications can be assigned a high priority level.

Determination of a behavior pattern for a user can be an ongoing process, such that a user's behavior pattern can evolve over time as additional user behavior is observed. Accordingly, it will be appreciated that priority levels assigned to applications can also evolve in accordance with a user's changing behavior pattern.

In some instances, a wireless communication device 102 can be used by multiple users. As such, in some example embodiments, a behavior pattern can be determined and application priority levels can be assigned for each respective user of a plurality of users using the wireless communication device 102.

The coex manager 222 can be configured to cooperate with the behavior module 220 to use priority levels assigned to applications to manage in-device coexistence decisions related to in-device interference when data communication is ongoing over multiple wireless communication interfaces, such as the first wireless communication interface 216 and the second wireless communication interface 218. In this regard, radio resource management (RRM) decisions can be made to optimize performance for high value applications as determined by the user's behavior pattern so as to avoid degradation of performance for high value applications when performing coexistence management for in-device interference resulting from using multiple wireless communication interfaces. For example, the coex manager can interact with a packet scheduler to help prioritize bearer flow of a high value application (e.g., an application having a higher assigned priority level) over a bearer flow for a low value application (e.g., an application having a lower assigned priority level).

As an example scenario, data communication for a first application having a high priority level can be ongoing over the first wireless communication interface 216 concurrent with data communication for a second application having a lower priority level than the first application over the second wireless communication interface 218. The first wireless communication interface 216 can use an aggressor RAT and the second wireless communication interface 218 can use a victim RAT such that data transmission via the first wireless communication interface 216 for the first application can act as an aggressor to data reception for the second application via the second wireless communication interface 218. However, even though data communication for the second application suffers as a victim, the coex manager 222 of some example embodiments can be configured to make coexistence decisions such that the data communication for the first application is not penalized or otherwise impacted by coexistence management actions, as the first application has the higher priority level in this example scenario. Thus, for example, the coex manager 222 may prevent dropping outgoing data associated with data communication for the first application. Data communication for the second application can instead be modified to occur around data transmission for the first application so as to avoid impacting the user's quality of experience with respect to the first application.

As a more particular example scenario, data traffic for a high value application can be transmitted over an aggressor LTE radio uplink, while data communication is ongoing for a WLAN downlink. The LTE radio uplink can act as an aggressor, impacting communication on the WLAN downlink, which can suffer as a victim. If the application associated with LTE uplink communication has a higher priority level than the application associated with the WLAN downlink communication, the coex manager 222 can be configured to prevent medium access control (MAC) protocol data units (PDUs) containing data associated with the first application for transmission on the LTE radio uplink from being dropped to reduce interference to the victim WLAN downlink, even if the LTE uplink is interfering with performance of the WLAN downlink.

As a further example scenario, data communication for a first application can be ongoing over the first wireless communication interface 216 concurrent with data communication for a second application over the second wireless communication interface 218. The second application can have a higher priority level than the first application. The first wireless communication interface 216 can use an aggressor RAT and the second wireless communication interface 218 can use a victim RAT such that data transmission via the first wireless communication interface 216 for the first application can act as an aggressor to data reception for the second application via the second wireless communication interface 218. As the second application has a higher priority than the first application in this example scenario, the coex manager 222 can be configured to at least temporarily increase a priority of the data communication for the second application over the second wireless communication interface 218 to preempt data communication for the first application so as to allow the data communication for the second application to occur without interference from the data communication for the first application.

As still a further example scenario, data communication for a first application can be ongoing over the first wireless communication interface 216 concurrent with data communication for a second application over the second wireless communication interface 218. The second application can have a higher priority level than the first application. The first wireless communication interface 216 can use an aggressor RAT and the second wireless communication interface 218 can use a victim RAT such that data transmission via the first wireless communication interface 216 for the first application can act as an aggressor to data reception for the second application via the second wireless communication interface 218. If inter-RAT handover of the data communication for the second application is possible without dropping the session, the coex manager 222 of some example embodiments can be configured to transition the data communication for the second application to the first wireless communication interface 216 so that the data communication does not suffer as a victim. In some such example embodiments, data communication for the first application can additionally be switched to the second wireless communication interface 218 to provide the second application with additional radio resources over the first wireless communication interface 216, such as in order to provide the second application with a threshold throughput level, threshold quality of service, and/or the like.

In embodiments in which priority levels are assigned for specific time frames and/or specific device usage contexts, the coex manager 222 can be further configured to make in-device coexistence decisions in accordance with application priority levels assigned for the time frame and/or device usage context in which in-device interference scenarios occur. Thus, for example, if data communication for a first application over the first wireless communication interface 216 is ongoing concurrent with data communication for a second application over the second wireless communication and device usage context-specific application priority levels are assigned, the coex manager 222 can be configured to manage in-device coexistence based at least in part on priority levels assigned to the first application and the second application for the device usage context existing during the concurrent data communication for the first application and the second application. As a further example, if data communication for a first application over the first wireless communication interface 216 is ongoing concurrent with data communication for a second application over the second wireless communication and time frame-specific application priority levels are assigned, the coex manager 222 can be configured to manage in-device coexistence based at least in part on priority levels assigned to the first application and the second application for a time frame in which the concurrent data communication for the first application and the second application occurs.

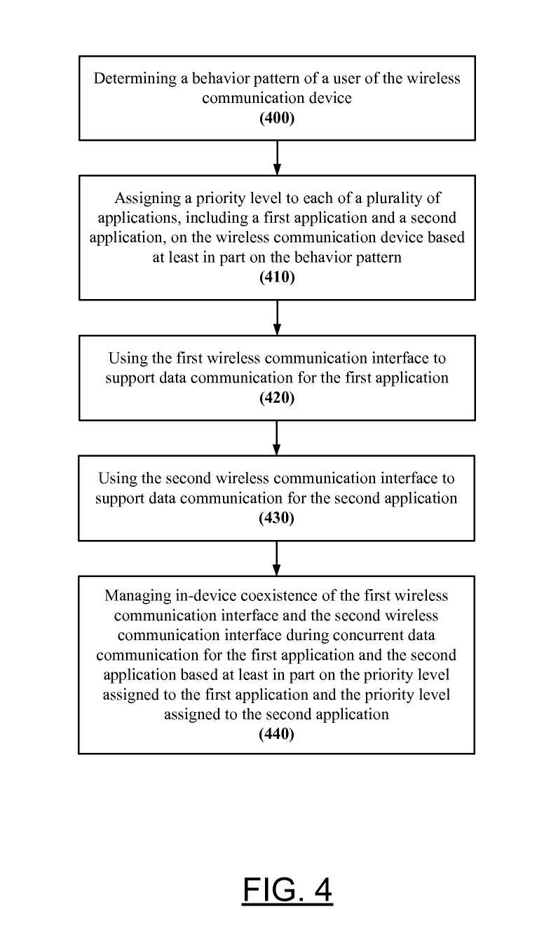

FIG. 4 illustrates a flowchart according to an example method for customized coexistence management based on user behavior in accordance with some example embodiments. In this regard, FIG. 4 illustrates operations that can be performed by a wireless communication device, such as wireless communication device 102, in accordance with some example embodiments. One or more of processing circuitry 210, processor 212, memory 214, first wireless communication interface 216, second wireless communication interface 218, behavior module 220, coex manager 222, or location module 224 can, for example, provide means for performing one or more of the operations illustrated in and described with respect to FIG. 4.

Operation 400 can include the wireless communication device 102 determining a behavior pattern of a user of the wireless communication device 102. Operation 410 can include the wireless communication device 102 assigning a priority level to each of a plurality of applications implemented on the wireless communication device 102 based at least in part on the behavior pattern. The plurality of applications can include a first application and a second application.

Operation 420 can include the wireless communication device 102 using the first wireless communication interface 216 to support data communication for the first application. For example, the data communication for the first application can be carried by radio link1 104. Operation 430 can include the wireless communication device 102 using the second wireless communication interface 218 to support data communication for the second application. For example, the data communication for the second application can be carried by radio link2 108.

Operation 430 can include the wireless communication device 102 managing in-device coexistence of the first wireless communication interface 216 and the second wireless communication interface 218 during concurrent data communication for the first application and the second application based at least in part on the priority level assigned to the first application and the priority level assigned to the second application.

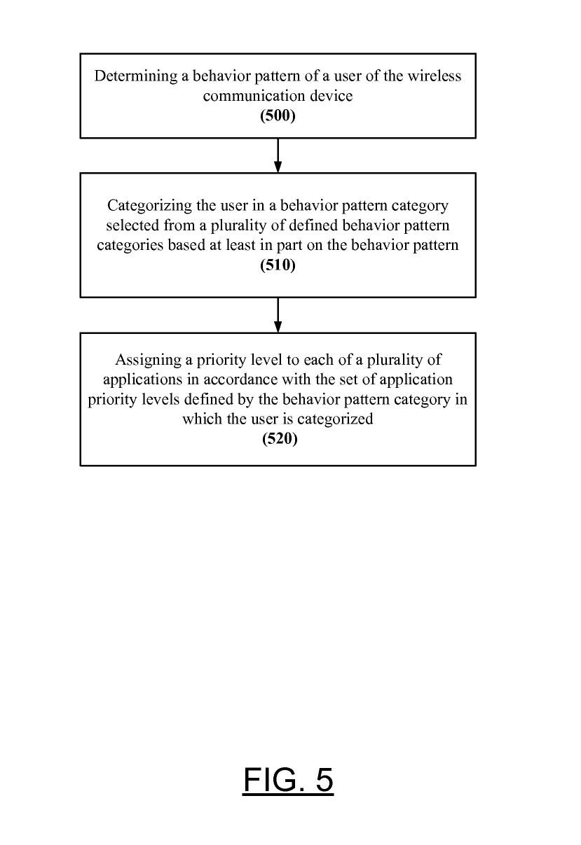

FIG. 5 illustrates a flowchart according to an example method for assigning priority levels to applications based on user behavior in accordance with some example embodiments. In this regard, FIG. 5 illustrates operations that can be performed by wireless communication device 102 attendant to performance of operations 400 and 410 in embodiments in which a user can be categorized into a defined behavior pattern category based at least in part on his or her behavior pattern. One or more of processing circuitry 210, processor 212, memory 214, first wireless communication interface 216, second wireless communication interface 218, behavior module 220, coex manager 222, or location module 224 can, for example, provide means for performing one or more of the operations illustrated in and described with respect to FIG. 5.

Operation 500 can include the wireless communication device 102 determining a behavior pattern of a user of the wireless communication device 102. In this regard, operation 500 can, for example, correspond to an embodiment of operation 400.

Operation 510 can include the wireless communication device 102 categorizing the user in a behavior pattern category selected from a plurality of defined behavior pattern categories based at least in part on the behavior pattern determined in operation 500. In this regard, the selected behavior pattern category can be the behavior pattern category most closely corresponding to the user's behavior pattern.

In some example embodiments, the coex manager 222 can be configured to consider whether an application is running in the foreground or background when making a coexistence management decision. In this regard, an application launched by a user and running in the foreground can be considered to have a higher value than a background application and can be given preferential treatment. Thus, for example the coex manager 222 can be configured in some example embodiments to make coexistence management decisions that reduce, or even avoid, impacting throughput for the application running in the foreground, even if data communication for the application in the foreground is impacting data communication for the background application. The consideration of whether an application is running in the foreground or in the background can be factored in addition to the respective priority levels of applications for which data communication is occurring when making coexistence management decisions.

In some example embodiments, the coex manager 222 can be further configured to factor a quality of service (QoS) level associated with an application when making a coexistence management decision. In this regard, data communication associated with an application associated with a higher QoS level can be given preferential treatment over data communication associated with an application having a lower QoS level, even if data communication associated with the application having the lower QoS level is suffering as a victim to the data communication for the application associated with the higher QoS level.

As a more particular example, if an application is mapped to QoS class indicator (QCI) 1 in an LTE network, the application can be considered higher value compared to an application mapped to QCI 7. As such, coexistence management can be performed to avoid impacting data communication for the application mapped to QCI 1, even if data communication for the application mapped to QCI 7 suffers as a victim to data communication for the application mapped to QCI 1.

The coex manager 222 can be further configured to consider the delay budget associated with a QCI. In this regard, a low latency application can be considered to have a higher value compared to a high latency application. Thus, for example, coexistence management can be performed to avoid impacting data communication for the low latency application, even if data communication for the high latency application suffers as a victim to data communication for the low latency application.

In a scenario in which the wireless communication device 102 is used by multiple users simultaneously, the coex manager 222 can be configured to give preference to data communication associated with an application used by a high priority user over data communication associated with an application used by a low priority user. As a particular example, the wireless communication device 102 of some example embodiments can be used in for ad hoc networking, such as if a second device is tethered to and/or otherwise in communication with the wireless communication device 102 to use a network connection of the wireless communication device 102. A user of the second device can be considered a guest user having a lower priority than the primary user of the wireless communication device 102. As such, the coex manager 222 of some example embodiments can be configured to consider data communication associated with the primary user of the wireless communication device 102 to be higher value than data communication associated with the guest user.

In some example embodiments, if a location-based service application, such as a location daemon, is the high value application at a given time, the behavior module 220 and coex manager 222 can be configured to work with the location module 224 to provide the location module 224 with access to a radio resource(s) that can be used to provide enhanced and/or otherwise more accurate location information than if the location module 224 did not have access to the radio resource(s). Thus, for example, the location module 224 can be provided with access to a radio resource at the expense of a lower priority application that can be using, or seeking to use, a radio resource for data communication at the same time. If, however, the location-based service application has a lower priority than another application, then the coex manager 222 can allocate radio resources to preserve and/or enhance performance of the higher value application rather than allocate additional radio resource(s) to the location-based service application.

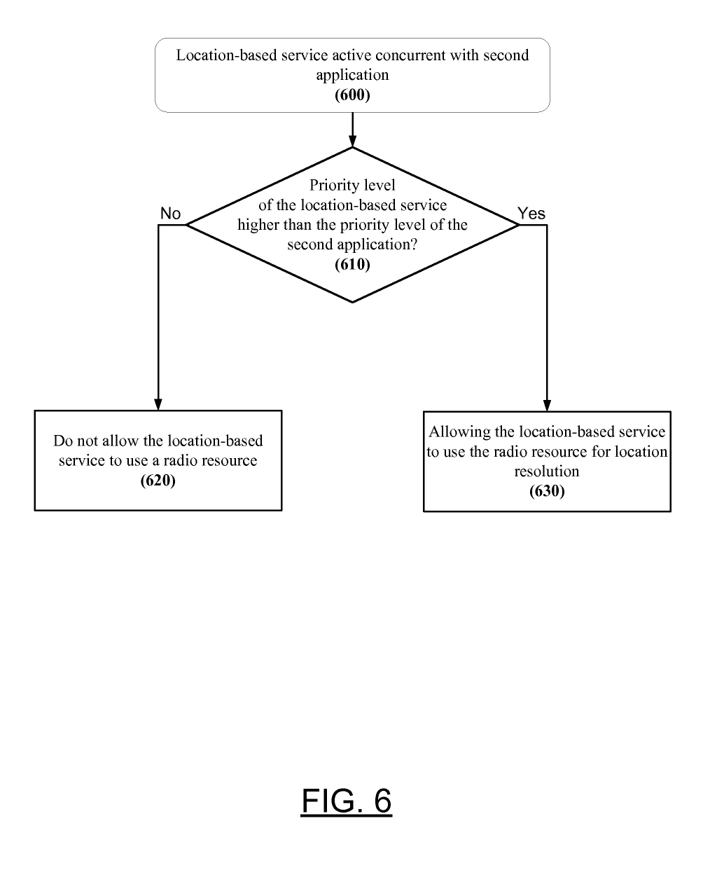

FIG. 6 illustrates a flowchart according to an example method for managing radio resources for location-based services based on user behavior in accordance with some such example embodiments. In this regard, FIG. 6 illustrates operations that can be performed by a wireless communication device, such as wireless communication device 102, in accordance with some example embodiments. One or more of processing circuitry 210, processor 212, memory 214, first wireless communication interface 216, second wireless communication interface 218, behavior module 220, coex manager 222, or location module 224 can, for example, provide means for performing one or more of the operations illustrated in and described with respect to FIG. 6.

Operation 600 can include a location-based service application being active concurrent with a second application. Operation 610 can include the wireless communication device 102 determining whether a priority level of the location-based service is higher than the priority level of the second application.

If the priority level of the location-based service is not higher than the priority level of the second application, the method can proceed to operation 620, in which the location-based service may not be allowed to use a radio resource. In this regard, for example, the second application can be allowed to use the radio resource rather than the location-based service. Alternatively, as another example, the radio resource can go unused so as to avoid causing interference to ongoing data communication for the second application. The radio resource can, for example, be an additional radio resource (or resources), which can allow the location-based service to derive a more accurate and/or otherwise enhanced location compared to a location that can be derived without access to the radio resource.

If, however, the priority level of the location-based service is higher than the priority level of the second application, the method can instead proceed to operation 630, which can include the wireless communication device 102 allowing the location-based service to use the radio resource (or resources) for location resolution. In this regard, the location-based service can be allowed to use an additional resource(s) to derive a more accurate and/or otherwise enhanced location compared to a location that can be derived without access to the radio resource. In some example embodiments, operation 630 can include allowing the location-based service to use the radio resource rather than the second application. Additionally or alternatively, in some example embodiments, operation 630 can include allowing the location-based service to use the radio resource even if use of the radio resource by the location-based service interferes with ongoing data communication associated with the second application.

Operations 610-630 can, for example, be performed attendant to performance of operation 440 in accordance with some example embodiments in which a location-based service is one of the two applications.

In some example embodiments, the coex manager 222 and/or other entity that can be responsible for interface selection on the wireless communication device 102 can be configured to use application priority levels that can be assigned based on a user behavior pattern in accordance with one or more example embodiments disclosed herein to select a wireless communication interfaces from available wireless communication interfaces, such as the first wireless communication interface 216 and the second wireless communication interface 218, to use for data communication for an application. In this regard, if a launched application has a high priority level (e.g., a priority level satisfying a threshold priority level), a wireless communication interface offering a best available radio link quality (e.g., best throughput, lowest latency, and/or the like) can be selected for the application to provide the user with a better quality of experience when using the application. If, however, a launched application has a low priority level (e.g., a priority level less than a threshold level), the application may not be provided with access to the wireless communication interface offering the best available radio link quality so that radio resources on the wireless communication interface offering the best available radio link quality can be used for another active application(s) having a higher priority level and/or reserved for use by an application having a higher priority level that may be launched in the future.

FIG. 7 illustrates a flowchart according to an example method for selecting a wireless communication interface for an application based on user behavior in accordance with some such example embodiments. In this regard, FIG. 7 illustrates operations that can be performed by a wireless communication device, such as wireless communication device 102, in accordance with some example embodiments. One or more of processing circuitry 210, processor 212, memory 214, first wireless communication interface 216, second wireless communication interface 218, behavior module 220, coex manager 222, or location module 224 can, for example, provide means for performing one or more of the operations illustrated in and described with respect to FIG. 7.

At operation 700, an application can be launched on the wireless communication device 102. Operation 710 can include the wireless communication device 102 determining the priority level assigned to the application.

Operation 720 can include the wireless communication device 102 selecting an available wireless communication interface to use for data communication for the application based at least in part on the priority level assigned to the application. As such, applications having higher priority levels can be mapped to a wireless communication interface offering a better radio link quality than applications having lower priority levels. Accordingly, user behavior driven priority levels can be used for interface selection in some embodiments to further provide a user with a customized user experience based on the user's historical behavior pattern.

In some example embodiments, the coex manager 222 and/or other entity that can be responsible for interface selection on the wireless communication device 102 can be configured to use application priority levels that can be assigned based on a user behavior pattern in accordance with one or more example embodiments disclosed herein to switch data communication for an active application from a first wireless communication interface, such as the first wireless communication interface 216, to a second wireless communication interface, such as the second wireless communication interface 218.

As an example scenario, data communication can for an application can be mapped to a first wireless communication interface 216 based on available wireless communication interfaces and/or available network coverage at a given time, such as at time of launch in accordance with the method illustrated in and described with respect to FIG. 7. After mapping data communication for the application to the first wireless communication interface 216, network coverage can become available over the second wireless communication interface 218 that can provide a better quality of experience for a user of the application than the existing radio link being used for data communication for the application over the first wireless communication interface 216. In this regard, the newly available network coverage over the second wireless communication interface 218 in this example scenario can, for example, offer better radio link quality (e.g., better throughput, lower latency, and/or the like) than the radio link over the first wireless communication interface 216 and/or offer a reduced level of in-device interference to the data communication for the application.

As a more particular example, data communication for an application can initially be mapped to a cellular communication interface. WLAN coverage may not have been available when the application was launched. Alternatively, available WLAN coverage when the application was launched may not have provided as good of a radio link quality as the cellular coverage, may not have been trusted by the wireless communication device 102, and/or the wireless communication device 102 may not have had security credentials to access the WLAN coverage. The user of the wireless communication device 102 may arrive at his or her house while data communication is ongoing such that the wireless communication device 102 may come within coverage of a home WLAN network for the user, which can offer a better quality of experience than the cellular link being used for data communication for the application.

If the data communication for the application can be handed over to the wireless communication interface via which the newly available network coverage can be accessed (e.g., without dropping the data communication session), the coex manager 222 of some example embodiments can be configured to switch the data communication for the application to the wireless communication interface via which the newly available network coverage can be accessed to enhance the quality of experience for the user. In some such example embodiments, the data communication can be switched between wireless communication interfaces if the application has an assigned priority level satisfying a threshold, such as if the application is a high value application for the user. If, however, the application has a low priority level (e.g., a priority level less than a threshold level), in some such example embodiments, data communication can be maintained on the existing wireless communication interface even after the wireless communication device 102 encounters the newly available network coverage.

FIG. 8 illustrates a flowchart according to an example method for switching a wireless communication interface for an application in accordance with some such example embodiments. In this regard, FIG. 8 illustrates operations that can be performed by a wireless communication device, such as wireless communication device 102, in accordance with some example embodiments. One or more of processing circuitry 210, processor 212, memory 214, first wireless communication interface 216, second wireless communication interface 218, behavior module 220, coex manager 222, or location module 224 can, for example, provide means for performing one or more of the operations illustrated in and described with respect to FIG. 8.

At operation 800, data communication for an active application can be mapped to a first wireless communication interface, such as the first wireless communication interface 216, implemented on the wireless communication device 102.

Operation 810 can include the wireless communication device 102 determining that network coverage is newly available over a second wireless communication interface, such as the second wireless communication interface 218, implemented on the wireless communication device 102. Operation 810 can further include determining that the newly available network coverage would offer a better quality of experience than the radio link being used for the data communication over the first wireless communication interface. For example, the RAT associated with the newly available network coverage can offer better throughput, lower latency, better QoS, and/or the like than the RAT being used for communication over the first wireless communication interface. As a further example, in some embodiments, operation 810 can include considering historic knowledge of a location of the wireless communication device 102 and/or knowledge of the newly available network coverage, itself, such as can be included in a behavior pattern determined for the user. For example, if the wireless communication device 102 is located at the user's home and the newly available network coverage is the user's home WLAN, then the wireless communication device 102 may have knowledge of a historic performance level of the user's home WLAN and can use this knowledge to determine that the newly available network coverage offers a better quality of experience than the radio link being used for the data communication over the first wireless communication interface.

In some example embodiments, if the newly available network coverage does not offer a better quality of experience than the radio link being used for the data communication over the first wireless communication interface, then operations 820-830, described below, can be omitted. As an example, a user can board a bus having on-board Wi-Fi coverage. However, the Wi-Fi coverage may be known by the wireless communication device 102 from prior observations to not provide a better quality of experience than cellular coverage. In such a scenario, the data communication for the application can be maintained on the cellular communication interface, and operations 820-830 can be omitted.

Operation 820 can include the wireless communication device 102 determining based at least in part on the priority level assigned to the application to switch the data communication for the application to the second wireless communication interface.

Operation 830 can include the wireless communication device 102 switching the data communication for the application to the second wireless communication interface. For example, operation 830 can include the wireless communication device 102 determining that a priority level assigned to the application satisfies a threshold priority level for switching to the second wireless communication interface.

In some example embodiments, user behavior patterns and/or assigned application priority levels can be synchronized across multiple wireless communication devices associated with a given user by a cloud-based synchronization service. FIG. 9 illustrates an example system 900 for synchronizing behavior patterns across multiple wireless communication devices in accordance with some such example embodiments.

The system 900 can include the wireless communication device 102, which can access a network 904. The network 904 can include one or more wireline networks, one or more wireless network (e.g., a cellular network, wireless local area network, wireless wide area network, some combination thereof, or the like), or a combination thereof, and in some example embodiments can include the Internet. In some example embodiments, the wireless communication device 102 can access the network 904 via a radio link that can be supported by the first wireless communication interface 216 or the second wireless communication interface 218. However, it will be appreciated that, in some example embodiments, the wireless communication device 102 can access the network 904 via a wireline connection.

The wireless communication device 102 can communicate with a synchronization service 902 over the network 904. The synchronization service 902 can be implemented as one or more computing devices, such as one or more servers, which can provide a cloud-based platform configured to provide synchronization services in accordance with various example embodiments. In some example embodiments, the synchronization service 902 can be provided by Apple® Inc.'s iCloud® platform and/or by other similar cloud-based synchronization platform.

The system 900 can further include a second wireless communication device 906, which can be embodied as any wireless communication device, such as a cellular phone, such as a smart phone device, a tablet computing device, a laptop computer, and/or other wireless communication device. In some example embodiments, the second wireless communication device 906 can be a second wireless communication device 102. The second wireless communication device 906 can be associated with one or more users that are also associated with the wireless communication device 102. While only two wireless communication devices are illustrated in the system 900, it will be appreciated that some users can have three or more wireless communication devices and example embodiments providing for synchronization across three or more such wireless communication devices are contemplated within the scope of the disclosure.

The wireless communication device 102 of some example embodiments can be configured to upload (e.g., periodically) a behavior pattern and/or application priority levels assigned for a user of the wireless communication device 102 to the synchronization service 902. For example, in some embodiments, the wireless communication device 102 can update a behavior pattern and/or application priority levels for a user maintained on the synchronization service 902 based on additional user behavior observed on the wireless communication device 102 since the previous update. The synchronization service 902 can be configured to synchronize the behavior pattern and/or application priority levels to the second wireless communication device 906. In this regard, coexistence management decisions can be made on the second wireless communication device 906 can be made based on the same behavior pattern and/or application priority levels as on the wireless communication device 102 such that the user can be provided with a similar quality of experience across multiple devices.

In some example embodiments, a user's behavior pattern can be determined based at least in part on the user's usage of multiple wireless communication devices. For example, characteristics of the user's usage of the second wireless communication device 906 can be provided to the synchronization service 902 and can be combined with information about the user's usage of the wireless communication device 902 to determine a behavior pattern of the user. In some such embodiments, the synchronization service 902 can provide information regarding the user's usage of the second wireless communication device 906 to the wireless communication device 102 and a behavior pattern for the user based on the aggregated usage information for the wireless communication device 102 and the second wireless communication device 906 can be determined on the wireless communication device 102.

However, in some example embodiments, the synchronization service 902 can collect usage information from both the wireless communication device 102 and the second communication device 906, and can locally determine a behavior pattern for the user at the synchronization service 902. In such example embodiments, at least a portion of the functionality of the behavior module 220 can be performed at the synchronization service 902 such that functionality of the behavior module 220 can be distributed between the wireless communication device 102 and synchronization service 902 in some example embodiments.

In some example embodiments in which a behavior pattern for the user can be determined by the synchronization service 902, the synchronization service 902 can be further configured to assign priority levels to applications implemented on the wireless communication device 102 and/or on the second wireless communication device 906 and provide the assigned priority levels to the wireless communication device 102 and/or to the second wireless communication device 906. However, in some example embodiments in which behavior pattern for the user can be determined by the synchronization service 902, the synchronization service 902 can provide the behavior pattern to the wireless communication device 102 and/or to the second wireless communication device 906 and application priority levels can be assigned locally at the wireless communication device 102 and/or at the second wireless communication device 906.

In some embodiments in which the synchronization service 902 assigns application priority levels and/or has access to priority levels assigned by the wireless communication device 102 and/or by the second wireless communication device 906, the synchronization service 902 can synchronize the application priority levels to another wireless communication device associated with a user. Thus, for example, in some embodiments, a wireless communication device, such as wireless communication device 102 and/or second wireless communication device 906, can query the synchronization service 902 for current application priority levels for a device user, and the synchronization service 902 can provide the application priority levels for the user in response to the query.

In some example embodiments, user behavior information and/or application priority levels that can be maintained on the synchronization service 902 can be used for marketing and advertising. For example, targeted advertising can be provided to wireless communication device 102 based on a behavior pattern and/or application priority levels for the user that are known to the synchronization service 902.

The various aspects, embodiments, implementations or features of the described embodiments can be used separately or in any combination. Various aspects of the described embodiments can be implemented by software, hardware or a combination of hardware and software. The described embodiments can also be embodied as computer readable code on one or more computer readable mediums. The computer readable medium can be any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

In the foregoing detailed description, reference was made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments. For example, it will be appreciated that the ordering of operations illustrated in the flowcharts is non-limiting, such that the ordering of two or more operations illustrated in and described with respect to a flowchart can be changed in accordance with some example embodiments. As another example, it will be appreciated that in some embodiments, one or more operations illustrated in and described with respect to a flowchart can be optional, and can be omitted.

Further, the foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. The description of and examples disclosed with respect to the embodiments presented in the foregoing description are provided solely to add context and aid in the understanding of the described embodiments. The description is not intended to be exhaustive or to limit the described embodiments to the precise forms disclosed. It will be apparent to one of ordinary skill in the art that many modifications, alternative applications, and variations are possible in view of the above teachings. In this regard, one of ordinary skill in the art will readily appreciate that the described embodiments may be practiced without some or all of these specific details. Further, in some instances, well known process steps have not been described in detail in order to avoid unnecessarily obscuring the described embodiments.

1. A method for customized coexistence management based on user behavior in a wireless communication device comprising a first wireless communication interface and a second wireless communication interface, the method comprising the wireless communication device:
determining a behavior pattern of a user of the wireless communication device, the behavior pattern being defined based at least in part on historical usage of the wireless communication device by the user;
assigning a priority level to each of a plurality of applications on the wireless communication device based at least in part on the behavior pattern, the plurality of applications including a first application and a second application;
using the first wireless communication interface to support data communication for the first application;
using the second wireless communication interface to support data communication for the second application concurrent with data communication for the first application over the first wireless communication interface; and
managing in-device coexistence of the first wireless communication interface and the second wireless communication interface during concurrent data communication for the first application and the second application based at least in part on the priority level assigned to the first application and the priority level assigned to the second application.

2. The method of claim 1, further comprising:
categorizing the user in a behavior pattern category selected from a plurality of defined behavior pattern categories based at least in part on the behavior pattern, the behavior pattern category defining a set of application priority levels; and
wherein assigning a priority level to each of the plurality of applications comprises assigning a priority level to each of the plurality of applications in accordance with the set of application priority levels defined by the behavior pattern category.

3. The method of claim 1, wherein:
assigning a priority level to each of the plurality of applications comprises assigning a different set of priority levels for each of a plurality of periodically occurring time frames; and
managing in-device coexistence of the first wireless communication interface and the second wireless communication interface comprises managing in-device coexistence of the first wireless communication interface and the second wireless communication interface based at least in part on priority levels assigned to the first application and the second application for a time frame in which the concurrent data communication for the first application and the second application occurs.

4. The method of claim 1, wherein:
assigning a priority level to each of the plurality of applications comprises assigning a different set of priority levels for each of a plurality of device usage contexts; and
managing in-device coexistence of the first wireless communication interface and the second wireless communication interface comprises managing in-device coexistence of the first wireless communication interface and the second wireless communication interface based at least in part on priority levels assigned to the first application and the second application for a device usage context of the wireless communication device during the concurrent data communication for the first application and the second application.

5. The method of claim 1, wherein the first wireless communication interface uses an aggressor radio access technology (RAT) that interferes with data reception via a victim RAT used by the second wireless communication interface, wherein the first application has a higher priority level than the second application, and wherein:
managing in-device coexistence of the first wireless communication interface and the second wireless communication interface comprises preventing dropping outgoing data associated with data communication for the first application.

6. The method of claim 1, wherein the first wireless communication interface uses an aggressor radio access technology (RAT) that interferes with data reception via a victim RAT used by the second wireless communication interface, wherein the second application has a higher priority level than the first application, and wherein:
managing in-device coexistence of the first wireless communication interface and the second wireless communication interface comprises at least temporarily increasing a priority of the data communication for the second application to preempt data communication for the first application.

7. The method of claim 1, wherein the first application is a location-based service having a higher priority level than the second application, and wherein:
managing in-device coexistence of the first wireless communication interface and the second wireless communication interface comprises allowing the location-based service to use a radio resource for location resolution at expense of the data communication for the second application.

8. The method of claim 1, further comprising the wireless communication device:
selecting to use the first wireless communication interface for data communication for the first application from a plurality of available wireless communication interfaces, including the first wireless communication interface and the second communication interface, based at least in part on the priority level assigned to the first application.

9. The method of claim 1, wherein the behavior pattern is defined further based on historical usage of a second wireless communication device by the user, and wherein the behavior pattern and at least a portion of the assigned priority levels are synchronized between the wireless communication device and the second wireless communication device via a synchronization service.

10. The method of claim 1, wherein managing in-device coexistence of the first wireless communication interface and the second wireless communication interface comprises managing in-device coexistence of the first wireless communication interface and the second wireless communication interface further based on one or more of a quality of service (QoS) level associated with the first application or a QoS level associated with the second application.

11. The method of claim 1, wherein managing in-device coexistence of the first wireless communication interface and the second wireless communication interface comprises managing in-device coexistence of the first wireless communication interface and the second wireless communication interface further based on whether the first application is running in foreground or in background.

12. A wireless communication device comprising:
a first wireless communication interface;
a second wireless communication interface; and
processing circuitry coupled with the first wireless communication interface and with the second wireless communication interface, the processing circuitry configured to control the wireless communication device to at least:
determine a behavior pattern of a user of the wireless communication device;
assign a priority level to each of a plurality of applications on the wireless communication device based at least in part on the behavior pattern, the plurality of applications including a first application and a second application;
use the first wireless communication interface for data communication for the first application;
use the second wireless communication interface for data communication for the second application; and
manage in-device coexistence of the first wireless communication interface and the second wireless communication interface for data communication for the first application and the second application based at least in part on the priority level assigned to the first application and the priority level assigned to the second application.

13. The wireless communication device of claim 12, wherein the processing circuitry is further configured to control the wireless communication device to:
categorize the user in a behavior pattern category selected from a plurality of defined behavior pattern categories based at least in part on the behavior pattern, the behavior pattern category defining a set of application priority levels; and
assign a priority level to each of the plurality of applications in accordance with the set of application priority levels defined by the behavior pattern category.

14. The wireless communication device of claim 12, wherein the processing circuitry is further configured to control the wireless communication device to:
assign a different set of priority levels for each of a plurality of periodically occurring time frames; and
manage in-device coexistence of the first wireless communication interface and the second wireless communication interface based at least in part on priority levels assigned to the first application and the second application for a time frame in which the concurrent data communication for the first application and the second application occurs.

15. The wireless communication device of claim 12, wherein the processing circuitry is further configured to control the wireless communication device to:
assign a different set of priority levels for each of a plurality of device usage contexts; and
manage in-device coexistence of the first wireless communication interface and the second wireless communication interface based at least in part on priority levels assigned to the device usage contexts.

16. The wireless communication device of claim 12, wherein the first wireless communication interface uses an aggressor radio access technology (RAT) that interferes with data reception via a victim RAT used by the second wireless communication interface, wherein the first application has a higher priority level than the second application, and wherein the processing circuitry is further configured to control the wireless communication device to:
manage in-device coexistence of the first wireless communication interface and the second wireless communication interface at least in part by controlling the wireless communication device to prevent dropping outgoing data associated with data communication for the first application.

17. The wireless communication device of claim 12, wherein the first wireless communication interface uses an aggressor radio access technology (RAT) that interferes with data reception via a victim RAT used by the second wireless communication interface, wherein the second application has a higher priority level than the first application, and wherein the processing circuitry is further configured to control the wireless communication device to:
manage in-device coexistence of the first wireless communication interface and the second wireless communication interface at least in part by controlling the wireless communication device to at least temporarily increase a priority of the data communication for the second application to preempt data communication for the first application.

18. The wireless communication device of claim 12, wherein the first application is a location-based service having a higher priority level than the second application, and wherein the processing circuitry is further configured to control the wireless communication device to:
manage in-device coexistence of the first wireless communication interface and the second wireless communication interface at least in part by controlling the wireless communication device to allow the location-based service to use a radio resource for location resolution at expense of the data communication for the second application.

19. A non-transitory computer readable storage medium having instructions stored thereon which, when executed at a wireless communication device, cause the wireless communication device to perform a method that includes:
determining a behavior pattern of a user of the wireless communication device; and
managing in-device coexistence of a plurality of wireless communication interfaces in the wireless communication device based on the behavior pattern.

20. The non-transitory computer readable storage medium of claim 19, wherein the method further includes:
assigning a priority level to each of a plurality of applications on the wireless communication device based at least in part on the behavior pattern, the plurality of applications including a first application and a second application;
wherein the managing the in-device coexistence of the plurality of wireless communication interfaces is further based on the priority level assigned to the first application and the priority level assigned to the second application.
